(19) United States
(12) Patent Application Publication
(10) Pub. No.: US 2025/0021802 A1
(43) Pub. Date: Jan. 16, 2025

(54) SCHEDULING DISTRIBUTED COMPUTING BASED ON COMPUTATIONAL AND NETWORK ARCHITECTURE

(71) Applicant: University of Southern California, Los Angeles, CA (US)

(72) Inventors: Bhaskar Krishnamachari, Los Angeles, CA (US); Mehrdad Kiamari, Los Angeles, CA (US)

(21) Appl. No.: 18/714,060

(22) PCT Filed: Sep. 28, 2022
(86) PCT No.: PCT/US2022/045108

§ 371 Date: May 28, 2024

Related U.S. Application Data
(60) Provisional application No. 63/283,928, filed on Nov. 29, 2021.

(51) Int. Cl. G06N 3/0464; H04L 41/16; H04L 43/0888

(52) U.S. Cl. CPC G06N 3/0464; H04L 41/16; H04L 43/0888

(57) ABSTRACT

A technical solution can include obtaining a first graph corresponding to a computational process, the graph including first nodes corresponding to respective tasks of the computational process, and first edges between pairs of the first nodes, each of the first edges corresponding to respective output from a first task of the tasks to a second task of the tasks, obtaining a second graph corresponding to a computer network architecture, the graph including second nodes corresponding to processing constraints at particular devices of the computer network architecture, and second edges between the nodes each corresponding to communication constraints between particular device, and generating, by machine learning, a trained model obtaining as input a combination of the first graph and the second graph, and indicating an assignment of one or more of the tasks to one or more of the devices.

### CROSS-REFERENCE TO RELATED PATENT APPLICATIONS

This application claims the benefit of priority under 35 U.S.C. § 119 to U.S. Provisional Patent Application Ser. No. 63/283,928, entitled “SCHEDULING DISTRIBUTED COMPUTING APPLICATIONS USING GRAPH CONVOLUTIONAL NETWORKS,” filed Nov. 29, 2021, the contents of such application being hereby incorporated by reference in its entirety and for all purposes as if completely and fully set forth herein.

### STATEMENT REGARDING FEDERALLY SPONSORED RESEARCH OR DEVELOPMENT

This invention was made with government support under Grant Number W911NF-17-2-0196, awarded by the Army Research Laboratory, and was made with government support under Grant Number HR00117C0053, awarded by the Defense Advanced Research Projects Agency. The government has certain rights in the invention.

### TECHNICAL FIELD

The present implementations relate generally to distributed computing systems, and more particularly to scheduling distributed computing based on computational and network architecture.

### INTRODUCTION

Computational systems are under increasing demand to maximize efficient allocation of resources and increase computational throughput across a wider range of architectures. Computational systems are also increasingly demanded for deployment on high-scale systems with heterogeneous system architectures. Heterogeneous architectures can introduce hardware constraints caused by particular portions of the architecture. Bottlenecks caused by particular hardware architectures can compound across large scale computational systems to degrade operation or eliminate successful operation of the computational system to efficiently or correctly generate output. The diverse range of computational hardware possible at large scales can significantly decrease the likelihood that a particular computational process executed by a particular high-scale computational environment will result in efficient and correct execution of the particular computational process by the particular high-scale computational environment.

### SUMMARY

Present implementations can include a system to optimize execution of a particular computational process on a particular distributed computing environment. The computational process can be based on a directed task graph, and can be advantageously optimized both based on multiple characteristics of both the hardware architecture across the distributed computing environment, and characteristics of the computational process at each portion of, for example, the task graph corresponding to the computational process. Thus, present implementations can advantageously optimized a high-scale distributed computed process across a particular non-generic distributed computing environment, based on one or more of the particular maximum hardware processing capability of each processor or computer device of the distributed computing environment, and the particular maximum bandwidth capability of each connection between each processor or computer device of the distributed computing environment. Thus, present implementations can advantageously address the technical problem of an inability to enable execution of large and distributed computational processes on particular hardware topologies of distributed computing environments, including where those hardware environments are not known in advance or are not stable over time during execution.

Present implementations can also maintain optimized execution of large and distributed computational processes on particular hardware topologies of distributed computing environments, by modifying the processors and connections on which particular tasks respectively execute and communicate. As one example, present implementations can modify a trained model based on a loss of bandwidth at one or more connections, to transfer execution of one or more tasks to nodes between surviving high-bandwidth connection of the distributed computing environment. As another example, present implementations can modify a trained model based on a loss of one or more mores of a distributed computing environment, due, for example, to power outage or device failure. A system can transfer execution of one or more tasks assigned to an offline node to another online node of the distributed computing environment with sufficient processor capability to execute the task. Because present implementations can include generation of modification of a trained model across an entire task graph and computational environment, present implementations can advantageously achieve a technical advantage of continued operation in response to partial system failure, and can maintain optimized performance across the entire distributed computing environment. Example implementations can maintain this resilience during run-time by retraining and changing the execution assignments during operation, in response to detecting a change or a loss of a processor, device, or connection, in the distributed computing environment. As one example, one or more teacher processes can train the model, and generating a trained model can be based at least partially on one or more existing scheduling processes or models. The scheduling processes or models can correspond to the teacher processes. Thus, a technological solution for scheduling distributed computing application using graph convolutional networks is provided.

A method can include obtaining a first graph corresponding to a computational process, the graph including one or more first nodes corresponding to respective tasks of the computational process, and one or more first edges between pairs of the first nodes, each of the first edges corresponding to respective output from a first task of the tasks to a second task of the tasks, obtaining a second graph corresponding to a computer network architecture, the graph including one or more second nodes corresponding to processing constraints at particular devices of the computer network architecture, and one or more second edges between the nodes each corresponding to communication constraints between particular device, and generating, by a machine learning process, a trained model as output, the trained model obtaining as input a combination of the first graph and the second graph, and indicating an assignment of one or more of the tasks to one or more of the devices.

In an example method, the generating is based on one or more first metrics each associated with computational factors of corresponding ones of the first nodes. In an example method, the generating is based on one or more second metrics each associated with processing factors of corresponding ones of the second nodes. In an example method, the generating is based on one or more third metrics each associated with output factors of corresponding ones of the first edges. In an example method, the generating is based on one or more fourth metrics each associated with bandwidth factors of corresponding ones of the second nodes. In an example method, the first graph and the second graph each include a respective directed graph. In an example method, the machine learning model includes a graph convolutional network model. In an example method, the generating is based on one or more existing scheduling models as a teacher model to train the model. A method can include mapping a task graph to hardware of a distributed computing system based on a trained machine learning model.

A system can include a memory and a processor. The system can obtain a first graph corresponding to a computational process, the graph including one or more first nodes corresponding to respective tasks of the computational process, and one or more first edges between pairs of the first nodes, each of the first edges corresponding to respective output from a first task of the tasks to a second task of the tasks. The system can obtain a second graph corresponding to a computer network architecture, the graph including one or more second nodes corresponding to processing constraints at particular devices of the computer network architecture, and one or more second edges between the nodes each corresponding to communication constraints between particular devices. The system can generate, by a machine learning process, a trained model as output, the trained model obtaining as input a combination of the first graph and the second graph, and indicating an assignment of one or more of the tasks to one or more of the devices.

The system can generate the trained model based on one or more first metrics each associated with computational factors of corresponding ones of the first nodes. The system can generate the trained model based on one or more second metrics each associated with processing factors of corresponding ones of the second nodes. The system can generate the trained model based on one or more third metrics each associated with output factors of corresponding ones of the first edges. The system can generate the trained model based on one or more fourth metrics each associated with bandwidth factors of corresponding ones of the second nodes. The first graph and the second graph can each comprise a respective directed graph. The machine learning model can include a graph convolutional network model. The system can generate the trained model based on one or more existing scheduling models as a teacher model to train the model. The system can map the graph to hardware of a distributed computing system based on the trained model.

A computer readable medium can include one or more instructions stored thereon and executable by a processor, to obtain, by the processor, a first graph corresponding to a computational process, the graph including one or more first nodes corresponding to respective tasks of the computational process, and one or more first edges between pairs of the first nodes, each of the first edges corresponding to respective output from a first task of the tasks to a second task of the tasks, obtain, by the processor, a second graph corresponding to a computer network architecture, the graph including one or more second nodes corresponding to processing constraints at particular devices of the computer network architecture, and one or more second edges between the nodes each corresponding to communication constraints between particular devices, and generate, by the processor via a machine learning process, a trained model as output, the trained model obtaining as input a combination of the first graph and the second graph, and indicating an assignment of one or more of the tasks to one or more of the devices.

The processor can generate the trained model based on one or more first metrics each associated with computational factors of corresponding ones of the first nodes, based on one or more second metrics each associated with processing factors of corresponding ones of the second nodes, and based on one or more fourth metrics each associated with bandwidth factors of corresponding ones of the second nodes.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 illustrates a system in accordance with present implementations.

FIG. 2 illustrates a computational server in accordance with present implementations.

FIG. 3 illustrates a computer architecture in accordance with present implementations.

FIG. 4 illustrates a task graph in accordance with present implementations.

FIG. 5 illustrates a graph neural network, in accordance with present implementations.

FIG. 6 illustrates an input graph, in accordance with present implementations.

FIG. 7 illustrates a first makespan performance diagram, in accordance with present implementations.

FIG. 8 illustrates a second makespan performance diagram, in accordance with present implementations.

FIG. 9 illustrates a third makespan performance diagram of a benchmark, in accordance with present implementations.

FIG. 10 illustrates an inference time diagram, in accordance with present implementations.

FIG. 11 illustrates a fourth makespan performance diagram, in accordance with present implementations.

FIG. 12 illustrates task graphs further to FIG. 11.

FIG. 13 illustrates a throughput performance diagram further to FIG. 12.

FIG. 14 illustrates a method of scheduling distributed computing based on computational and network architecture, in accordance with present implementations.

FIG. 15 illustrates a method of scheduling distributed computing based on computational and network architecture, in accordance with present implementations.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

Present implementations can advantageously optimize the computational process for, as one example, the hardware of the distributed computing environment, based on two factors derived from the task graph of the computational process, and two factors based on a computer network graph of the distributed computing environment. The computer network graph can be based on the hardware computing devices of the distributed computing system, as nodes, and the communication channels between each node, as edges. The task graph can similarly be based on the computational requirements of each task, as nodes, and the amount of data passed from task to task, as edges. A first factor can indicate an amount of computation at a particular node of the task graph to complete a computation associated with the node. A second factor can indicate a maximum computational speed at each node, for each processor or computer device, in the computer network graph. A third factor can indicate, for each directed edge of the task graph, an amount of data passed from a particular node to another particular node. A fourth factor can indicate, for each directed edge of the computer network graph, a maximum bandwidth, for example, between particular nodes of the computer network graph. A machine learning system in accordance with present implementations can obtain the four factors for one or more nodes and edges of the task graph and the computer network graph, and can generate as output of the machine learning system, a trained model indicating the particular processors or devices on which particular nodes of the task graph are to be executed, and particular communication channels by which particular communications between particular processors are to be conducted, to ensure that all of the computational and bandwidth requirements of the task graph are satisfied by particular processors or devices, and communication channels of the particular distributed computing environment. Processing factors can include one or more of the factors discussed above.

Successfully running complex graph-based applications, including for example edge-cloud processing in IoT systems and processing astronomical observations, heavily relies on executing all sub-components of such applications through an efficient task-scheduling. Not only does efficient task scheduling play a crucial role in improving the utilization of computing resources and reducing the required time to executing tasks, it can also lead to significant profits to service providers. As one example, an application can include of multiple tasks with a given inter-task data dependency structure, where each task can generate inputs for certain other tasks. Such dependencies can be expressed, for example, as a directed acyclic graph (DAG), also known as task graph, where vertices and edges represent tasks and intertask data dependencies, respectively. An input job for an application can be completed once all the tasks are executed by compute machines according to the inter-task dependencies. As one example, a task graph can include a directed graph, and a computer network graph can include an undirected graph. The network graph can be undirected if, for example, network traffic in both directions of a communication channel is capable of the same or similar bandwidth.

Present implementations can include two example metrics for schedulers to optimize: makespan and throughput. The required time to complete all tasks for a single input can correspond to makespan. The maximum steady state rate at which inputs can be processed in a pipelined manner can correspond to throughput. Makespan minimization and throughput maximization can each be achieved through relevant efficient task scheduling that assigns tasks to appropriate distributed computing resources to be executed. Present implementations can overcome disadvantages of conventional scheduling schemes by performing effectively on a task graph that becomes large or extremely large, which require long computation times. Applications in many domains, including for example IoT for smart cities can result in increasingly complex applications with numerous inter-dependent tasks, and scheduling may need to be repeated frequently in the presence of network or resource dynamics. Therefore, present implementations are advantageously directed at least to a faster method to schedule tasks for task graphs of arbitrary size, including large-scale task graphs.

Present implementations can apply machine learning techniques for function approximation, leveraging the fact that scheduling essentially has to do with finding a function mapping tasks to compute machines. Given the graph structure of applications, a graph convolutional network (GCN) can schedule tasks through learning the inter-task dependencies of the task graph as well as network settings in order to extract the relationship between different entities. Network settings can include but are not limited to execution speed of compute machines and communication bandwidth across machines. The GCN can advantageously address many graph-based applications to perform semi-supervised link prediction and node classification. GCN can construct node embeddings layer by layer. In each layer, a node embedding is achieved by aggregating its neighbors' embeddings, followed by a neural network (i.e. a linear transformations and nonlinear activation). In case of node classification, the last layer embedding is given to a softmax operator to predict node labels, and consequently the parameters of GCN can be learned in an end-to-end manner. Two example types of GCNs include spectral-based GCNs and special-based ones. To obtain node embedding, the former can use matrix decomposition of Laplacian matrix, which results in scalability issues due to nonlinear computation complexity of the decomposition, while the latter does not have such complexity thanks to the idea of message-passing.

Thus, present implementations are advantageously directed to implementing at least a spatial-based GCN, incorporated with features of both nodes and edges for task graphs, to perform scheduling over distributed computing systems. A scheduler supporting GCN can quickly schedules tasks by carefully integrating a task graph with network settings into a single input graph and feeding it to an appropriate GCN model. The scheduler is compatible with arbitrary scheduling constraints that can be used as a teacher to train GCNScheduler, for any metric. Training, by way of example, can include GCNScheduler using HEFT for makespan minimization, and TP-HEFT for throughput maximization.

Thus, a scheduler of present implementations can be trained in a short period of time, with scheduling performance comparable to a teacher model. For instance, it takes around <15 seconds to train a graph with 8,000 nodes. Present implementations give comparable or better scheduling performance in terms of makespan with respect to HEFT and throughput with respect to TP-HEFT, respectively. The scheduler can be several orders of magnitude faster than previous heuristic models in obtaining the schedule for a given task graph. For example, for makespan minimization, GCNScheduler schedules 50-node task graphs in about 4 milliseconds while HEFT takes more than 1500 seconds; and for throughput maximization, GCNScheduler schedules 100-node task graphs in about 3.3 milliseconds, compared to about 6.9 seconds for TP-HEFT. The scheduler can efficiently perform scheduling for any size task graph, and can operate over large-scale task graphs where conventional schemes require excessive computational resources.

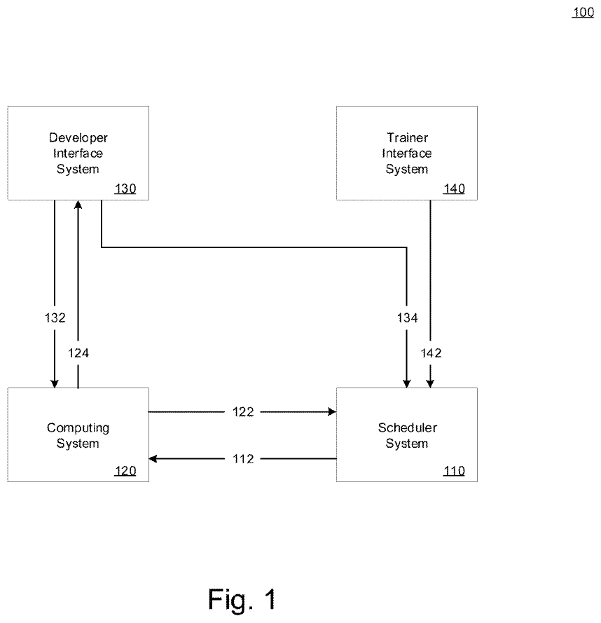

FIG. 1 illustrates a system in accordance with present implementations, with users and components and their roles in a possible distributed computing system where a scheduler is deployed. As illustrated by way of example in FIG. 1, an example system 100 can include a scheduler system 110, a computing system 120, a developer interface system 130, and a trainer interface system 140.

The scheduler system 110 can include a server, computing device, or distributed computing system, for example. The scheduler system 110 can include a computational server and can include a task profiler, a task dispatcher, and a scheduler. The scheduler can be based on a graph convolutional network architecture. The scheduler system 110 can train a model based, for example, on a convolutional neural network. The scheduler system 110 can generate a profile based on the model, and can generate a task execution schedule based on the model, the profile, or both. The trainer interface system 140 can include a user interface and a communication interface, and can transmit training data and teacher models to the scheduler system 110. The trainer interface system 140 can obtain input via a user interface and can transmit training data based on the input via a communication channel 112 coupled with the scheduler system 110. The scheduler system 110 can obtain input to train the model via a communication channel 142 that couples the scheduler system 110 with the trainer interface system 140. The scheduler system 110 can obtain input to train or retrain the model via a communication channel 122 that couples the scheduler system 110 with the computing system 120, and can transmit instructions to define or perform one or more tasks by a communication channel 112 that couples the scheduler system 110 with the computing system 120.

The computing system 120 can include a particular type of computing device or collection of computing devices. The computing system 120 can be managed by an application developer or user, or by a third party system. The computing system 120 can obtain a specification or a profile from the developer interface system 130. The computing system 120 can obtain one or more tasks from the scheduler system 110, and can execute those task in accordance with a model, schedule, profile, or any combination thereof, of the scheduler system 110. The computing system 120 can transmit one or more state or status indications to the developer interface system 130 via a communication interface 124 that couples the computing system 120 with the developer interface system 130.

The developer interface system 130 can include a user interface and a communication interface, and can transmit a specification and a profile corresponding to a task graph to the scheduler system developer interface system 130, via a communication interface 132 that couples the developer interface system 130 with the computing system 120. The developer interface system 130 can provision the computing system 120 and can provide instructions to the computing system 120 to self-provision, via a communication interface 132 that couples the developer interface system 130 with the computing system 120. The specification can define one or more of a task graph and an application corresponding to a particular type of computing device or collection of computing devices of the computing system 120 or compatible therewith. The profile can define one or more modification to a particular specification that maintain compatibility with a particular type of computing device or collection of computing devices of the computing system 120.

The scheduler can be trained as follows, by way of example. Each “Teacher Process,” which works according to a particular objective metric) can follow the following sub-steps. First the teach can create a sufficient number of random task graphs with random required computations amount for each task, or real task graphs associated with actual production task flows, or any combination thereof. The teacher can then integrate each of above-mentioned task graphs and their required computations information with the computer's network information into an input graph. The input graph can have the same set of nodes and edges as the original task graph while equipped with designed features for both nodes and edges as well as labels for both nodes and edges. The features of a node Tᵤ (representing task Tᵤ in the task graph) can be the required computational time of task Tᵤ across all computers. The features of an edge (representing an edge in the task graph) from task Tᵤ to task Tᵥ can be the required time of transferring the result of execution of task Tᵤ to the following task Tᵥ across all possible pairwise computers. The label of node Tᵤ (representing task Tᵤ in the task graph) can include the index of the computer that the teacher model assigns task Tᵤ to run on. The label of an edge from task Tᵤ to task Tᵥ can include the index of the computer that the teacher model assigns task Tᵤ to run on.

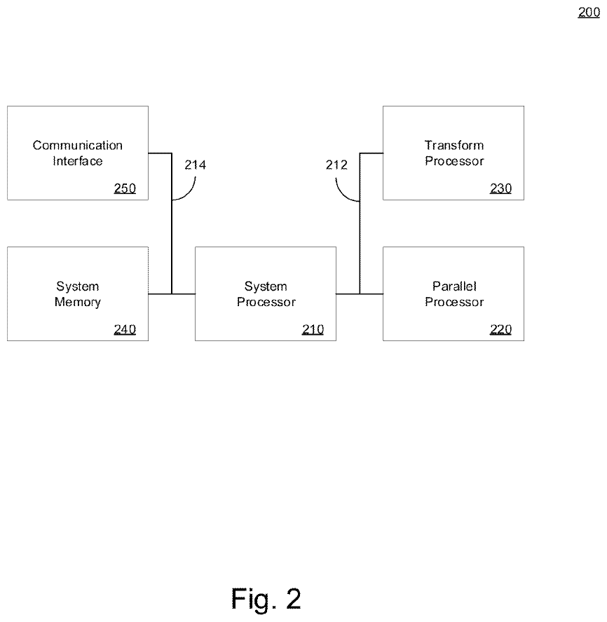

FIG. 2 illustrates a computational server in accordance with present implementations. As illustrated by way of example in FIG. 2, an example processing system 200 includes a system processor 210, a parallel processor 220, a transform processor 230, a system memory 240, and a communication interface 250. In some implementations, at least one of the example processing system 200 and the system processor 210 includes a processor bus 212 and a system bus 214.

The system processor 210 is operable to execute one or more instructions. In some implementations, the instructions are associated with at least one of the system memory 240 and the communication interface 250. In some implementations, the system processor 210 is an electronic processor, an integrated circuit, or the like including one or more of digital logic, analog logic, digital sensors, analog sensors, communication buses, volatile memory, nonvolatile memory, and the like. In some implementations, the system processor 210 includes but is not limited to, at least one microcontroller unit (MCU), microprocessor unit (MPU), central processing unit (CPU), graphics processing unit (GPU), physics processing unit (PPU), embedded controller (EC), or the like. In some implementations, the system processor 210 includes a memory operable to store or storing one or more instructions for operating components of the system processor 210 and operating components operably coupled to the system processor 210. In some implementations, the one or more instructions include at least one of firmware, software, hardware, operating systems, embedded operating systems, and the like.

The processor bus 212 is operable to communicate one or more instructions, signals, conditions, states, or the like between one or more of the system processor 210, the parallel processor 220, and the transform processor 230. In some implementations, the processor bus 212 includes one or more digital, analog, or like communication channels, lines, traces, or the like. It is to be understood that any electrical, electronic, or like devices, or components associated with the system bus 214 can also be associated with, integrated with, integrable with, supplemented by, complemented by, or the like, the system processor 210 or any component thereof.

The system bus 214 is operable to communicate one or more instructions, signals, conditions, states, or the like between one or more of the system processor 210, the system memory 240, and the communication interface 250. In some implementations, the system bus 214 includes one or more digital, analog, or like communication channels, lines, traces, or the like. It is to be understood that any electrical, electronic, or like devices, or components associated with the system bus 214 can also be associated with, integrated with, integrable with, supplemented by, complemented by, or the like, the system processor 210 or any component thereof.

The parallel processor 220 is operable to execute one or more instructions concurrently, simultaneously, or the like. In some implementations, the parallel processor 220 is operable to execute one or more instructions in a parallelized order in accordance with one or more parallelized instruction parameters. In some implementations, parallelized instruction parameters include one or more sets, groups, ranges, types, or the like, associated with various instructions. In some implementations, the parallel processor 220 includes one or more execution cores variously associated with various instructions. In some implementations, the parallel processor 220 includes one or more execution cores variously associated with various instruction types or the like. In some implementations, the parallel processor 220 is an electronic processor, an integrated circuit, or the like including one or more of digital logic, analog logic, communication buses, volatile memory, nonvolatile memory, and the like. In some implementations, the parallel processor 220 includes but is not limited to, at least one graphics processing unit (GPU), physics processing unit (PPU), embedded controller (EC), gate array, programmable gate array (PGA), field-programmable gate array (FPGA), application-specific integrated circuit (ASIC), or the like. It is to be understood that any electrical, electronic, or like devices, or components associated with the parallel processor 220 can also be associated with, integrated with, integrable with, supplemented by, complemented by, or the like, the system processor 210 or any component thereof.

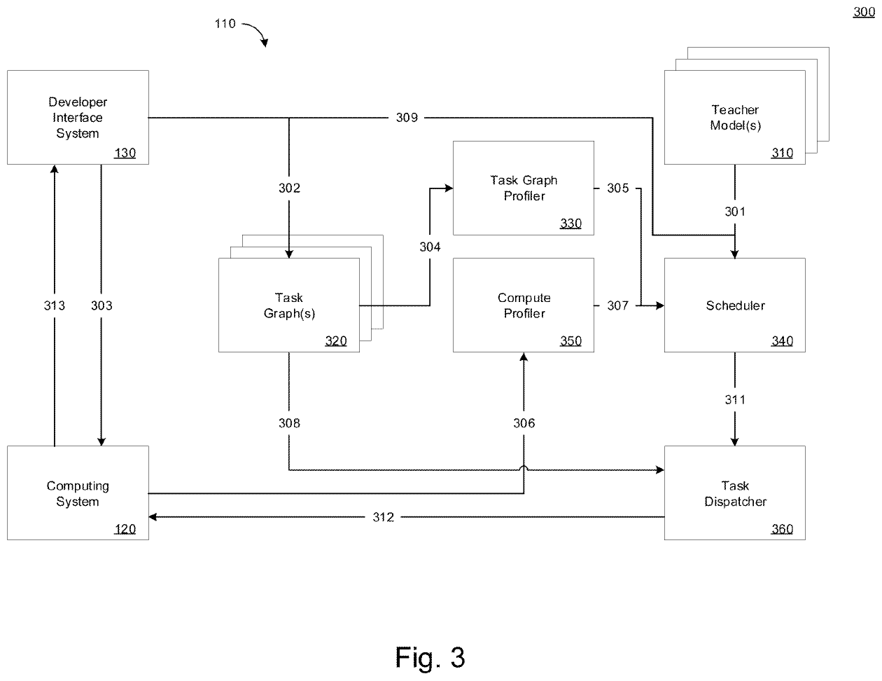

In some implementations, various cores of the parallel processor 220 are associated with one or more parallelizable operations in accordance with one or more metrics, engines, models, and the like, of the example computing system of FIG. 3. As one example, parallelizable operations include processing portions of an image, video, waveform, audio waveform, processor thread, one or more layers of a learning model, one or more metrics of a learning model, one or more models of a learning system, and the like. In some implementations, a predetermined number or predetermined set of one or more particular cores of the parallel processor 220 are associated exclusively with one or more distinct sets of corresponding metrics, engines, models, and the like, of the example computing system of FIG. 3. As one example, a first core of the parallel processor 220 can be assigned to, associated with, configured to, fabricated to, or the like, execute one engine of the example computing system of FIG. 3. In this example, a second core of the parallel processor 220 can also be assigned to, associated with, configured to, fabricated to, or the like, execute another engine of the example computing system of FIG. 3. Thus, in some implementations, the parallel processor 220 is configured to parallelize execution across one or more metrics, engines, models, and the like, of the example computing system of FIG. 3. Similarly, in some implementations, a predetermined number or predetermined set of one or more particular cores of the parallel processor 220 are associated collectively with corresponding metrics, engines, models, and the like, of the example computing system of FIG. 3. As one example, a first plurality of cores of the parallel processor can be assigned to, associated with, configured to, fabricated to, or the like, execute one engine of the example computing system of FIG. 3. In this example, a second plurality of cores of the parallel processor can also be assigned to, associated with, configured to, fabricated to, or the like, execute another engine of the example computing system of FIG. 3. Thus, in some implementations, the parallel processor 220 is configured to parallelize execution within one or more metrics, engines, models, and the like, of the example computing system of FIG. 3.

The transform processor 230 is operable to execute one or more instructions associated with one or more predetermined transformation processes. As one example, transformation processes include Fourier transforms, matrix operations, calculus operations, combinatoric operations, trigonometric operations, geometric operations, encoding operations, decoding operations, compression operations, decompression operations, image processing operations, audio processing operations, and the like. In some implementations, the transform processor 230 is operable to execute one or more transformation processes in accordance with one or more transformation instruction parameters. In some implementations, transformation instruction parameters include one or more instructions associating the transform processor 230 with one or more predetermined transformation processes. In some implementations, the transform processor 230 includes one or more transformation processes. Alternatively, in some implementations, the transform processor 230 is a plurality of transform processor 230 associated with various predetermined transformation processes. Alternatively, in some implementations, the transform processor 230 includes a plurality of transformation processing cores each associated with, configured to execute, fabricated to execute, or the like, a predetermined transformation process. In some implementations, the parallel processor 220 is an electronic processor, an integrated circuit, or the like including one or more of digital logic, analog logic, communication buses, volatile memory, nonvolatile memory, and the like. In some implementations, the parallel processor 220 includes but is not limited to, at least one graphics processing unit (GPU), physics processing unit (PPU), embedded controller (EC), gate array, programmable gate array (PGA), field-programmable gate array (FPGA), application-specific integrated circuit (ASIC), or the like. It is to be understood that any electrical, electronic, or like devices, or components associated with the transform processor 230 can also be associated with, integrated with, integrable with, supplemented by, complemented by, or the like, the system processor 210 or any component thereof.

In some implementations, the transform processor 230 is associated with one or more predetermined transform processes in accordance with one or more metrics, engines, models, and the like, of the example computing system of FIG. 3. In some implementations, a predetermined transform process of the transform processor 230 is associated with one or more corresponding metrics, engines, models, and the like, of the example computing system of FIG. 3. As one example, the transform processor 230 can be assigned to, associated with, configured to, fabricated to, or the like, execute one matrix operation associated with one or more engines, metrics, models, or the like, of the example computing system of FIG. 3. As another example, the transform processor 230 can alternatively be assigned to, associated with, configured to, fabricated to, or the like, execute another matrix operation associated with one or more engines, metrics, models, or the like, of the example computing system of FIG. 3. Thus, in some implementations, the transform processor 230 is configured to centralize, optimize, coordinate, or the like, execution of a transform process across one or more metrics, engines, models, and the like, of the example computing system of FIG. 3. In some implementations, the transform processor is fabricated to, configured to, or the like, execute a particular transform process with at least one of a minimum physical logic footprint, logic complexity, heat expenditure, heat generation, power consumption, and the like, with respect to at least one metrics, engines, models, and the like, of the example computing system of FIG. 3.

The system memory 240 is operable to store data associated with the example processing system 200. In some implementations, the system memory 240 includes ones or more hardware memory devices for storing binary data, digital data, or the like. In some implementations, the system memory 240 includes one or more electrical components, electronic components, programmable electronic components, reprogrammable electronic components, integrated circuits, semiconductor devices, flip flops, arithmetic units, or the like. In some implementations, the system memory 240 includes at least one of a non-volatile memory device, a solid-state memory device, a flash memory device, and a NAND memory device. In some implementations, the system memory 240 includes one or more addressable memory regions disposed on one or more physical memory arrays. In some implementations, a physical memory array includes a NAND gate array disposed on a particular semiconductor device, integrated circuit device, printed circuit board device, and the like.

The communication interface 250 is operable to communicatively couple the system processor 210 to an external device. In some implementations, an external device includes but is not limited to a smartphone, mobile device, wearable mobile device, tablet computer, desktop computer, laptop computer, cloud server, local server, and the like. In some implementations, the communication interface 250 is operable to communicate one or more instructions, signals, conditions, states, or the like between one or more of the system processor 210 and the external device. In some implementations, the communication interface 250 includes one or more digital, analog, or like communication channels, lines, traces, or the like. As one example, the communication interface 250 is or includes at least one serial or parallel communication line among multiple communication lines of a communication interface. In some implementations, the communication interface 250 is or includes one or more wireless communication devices, systems, protocols, interfaces, or the like. In some implementations, the communication interface 250 includes one or more logical or electronic devices including but not limited to integrated circuits, logic gates, flip flops, gate arrays, programmable gate arrays, and the like. In some implementations, the communication interface 250 includes ones or more telecommunication devices including but not limited to antennas, transceivers, packetizers, wired interface ports, and the like. It is to be understood that any electrical, electronic, or like devices, or components associated with the communication interface 250 can also be associated with, integrated with, integrable with, replaced by, supplemented by, complemented by, or the like, the system processor 210 or any component thereof.

FIG. 3 illustrates a computer architecture in accordance with present implementations, including an overview of an overall distributed computing system showing how a scheduler is trained and used. As illustrated by way of example in FIG. 3, an example architecture 300 can include the scheduler system 110, the computing system 120, and the scheduler system 110. For example, the scheduler system 110 can include one or more teacher models 310, one or more task graphs 320, a task graph profiler 330, a scheduler 340, a compute profiler 350, and a task dispatcher 360.

At 310, one or more existing Teacher Models, each of which may have been designed to optimize a different objective metric (such as HEFT for makespan), can train the GCNScheduler. The training process here, for example, involves training the Graph Convolutional Network implementing the GCNScheduler and results in a trained model or a set of trained models, one (or possibly even more than one model) for each metric using a set of task graphs, which could be potentially randomly generated (see training details below). Once trained, a GCNScheduler model could be implemented as a software running on a computer or as a special-purpose hardware.

At 302, the party or parties that is responsible for designing/deploying/using the complex application or operating the system that runs the application can provide the software implementation of the complex application containing all the component tasks and their dependencies, and their logical representation. Since there are inter-task data dependencies (i.e. some tasks require other task's outputs), the representation can advantageously be represented by a directed graph, called a task graph.

At 303, the developer interface system 130 can query the computing system 120 on which the complex application can be executed. The computing system 120 may correspond to a data center, a cloud computing location, or a collection of geographically-separated cloud-based servers, or a hybrid edge-cloud compute network.

At 304, the software implementation and task graph could be provided to the task graph profiler 330 which determines the required computations amount needed by each task, and the amount of data that must be sent between pairs of tasks. The task graph profiler 330 may determine this by running the tasks on different machines. In general, these task computation amounts and data outputs may be statistical in nature so the profiler may need to run the software with different inputs to generate statistics and estimate parameters such as the average computational work for each task (which could be different for different types/architectures of computers) and the average amount of data sent between tasks, or collect and output raw statistical estimates.

At 305, raw statistics or estimated parameters for the task computation time and inter-task data size along with the task graph information can be sent from the task graph profiler 330 to the scheduler 340.

At 306, based on the architecture of the computing system 120, the compute profiler 350 determines the relevant settings from that computer network such as the execution speed of different computers, their available CPU utilization, memory and other resources, the communication bandwidth across different links on the computer network, the maximum outgoing and incoming bandwidths of computers, etc.

At 307, information from the computer and network profiler such as compute speeds and network link bandwidths can be provided to the GCNScheduler.

At 308, the task graph profiler 330 corresponding to one or more task graphs 320 sends instructions implementing each task along with the information about their inter-task dependencies to the scheduler 340.

At 309, the developer interface system 130 can specify their desired objective function/metric to scheduler 340 to find the scheduling according to the given objective function. For example, the objective may be to minimize makespan, or maximize throughput, or minimize cost, or minimize energy, etc.

The scheduler 340, depending on the selected objective function, can use an appropriate model from the scheduler 340. The selected GCNScheduler model (which could be implemented as a software running on a non-generic computer, or as a special-purpose hardware) will use the inputs about the task graph, task computation requirement and inter-task data size, as well as inputs about computer speeds and network bandwidths. The output of the scheduler 340 can be a schedule. The output schedule maps each task of the task graph to a computer on the computer network, and indicates the order in which they should be executed. At 311, the schedule output by the scheduler 340 can be sent to the task dispatcher 360.

At 312, the task dispatcher 360 sends each task from the complex application being deployed to the computers in the computing system 120. In one instantiation, the task dispatcher 360 will send only the code corresponding to the schedule which indicates which task is mapped to a given computer; in another instantiation, the dispatcher may send code corresponding to many or all tasks to each computer in the network of computers, along with information about at least one of the schedule and task mapping so that each computer knows which task(s) it is responsible for executing.

At 313, the complex application will then be executed on the network of computers; depending on the application, intermediate results or status information may be provided to the developer interface system 130 while it is running; or only the final results from the computation may be provided. While the application is running, input data for the computation may be provided by the user/operator or from any data source such as an IoT sensor, video camera, etc. The output results from the computation may also be sent directly to control some other system, or stored in a storage device.

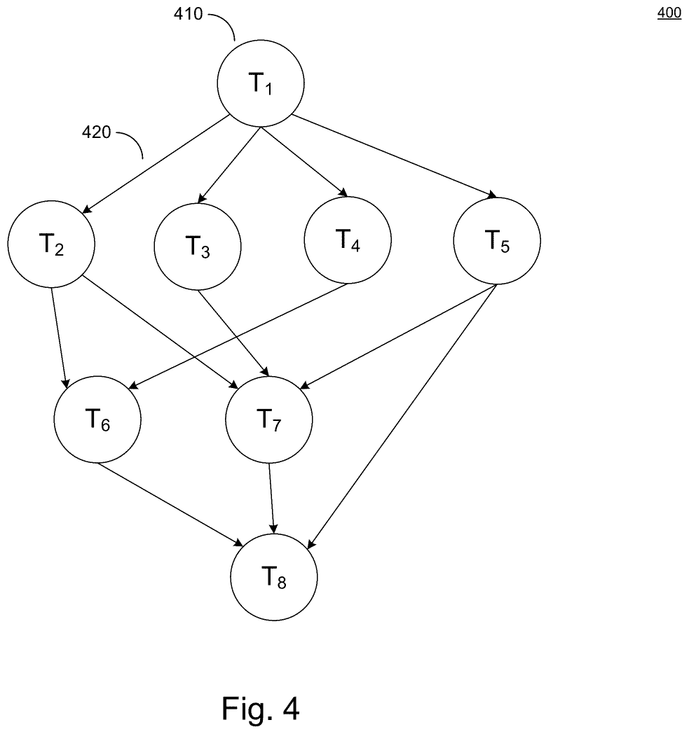

FIG. 4 illustrates a task graph in accordance with present implementations, including an example of task graph, which is in the form of a DAG, with eight tasks. As illustrated by way of example in FIG. 4, an example task graph 400 can include nodes 410 and edges 420. For instance, task T7 requires tasks T2, T3, and T5 to be first executed and generate their outputs before executing task T7. Tasks T1-T8 can correspond to nodes 410, and outputs of various nodes can correspond to edges 420.

Every application/job can include inter-task data dependencies. Where there are dependencies across different tasks, meaning that a task generates inputs for certain other tasks, the task graph can model this dependency through a DAG. Suppose a system can have N_{T} tasks {Tᵢ}ᵢ₌₁^{N}^{_{T}} with a given task graph G_{Task}:=(V_{Task},E_{Task}) where V_{Task}:={Tᵢ}ᵢ₌₁^{N}^{_{T}} and E_{Task}:={e_{i,i′}}_{(i,i′)∈Ω} respectively represent the set of vertices and edges (task dependencies) with Ω:={(i,i′)| if task Tᵢ, generates inputs for task T_{i′}}. For example, define vector p:=[p₁, . . . , p_{N}_{_{T}}]^{T} as the amount of computations required by tasks. For every tasks Tᵢ and Tⱼ, ∀i, j where e_{i,j}∈E_{Task}, task Tᵢ produces d_{i,j} amount of data for task Tⱼ after being executed by a machine.

Each task can be executed on a compute node (machine) which is connected to other compute nodes (machines) through communication links (compute node and machine are interchangeably used in this paper). Suppose N_{C} compute nodes {Cⱼ}ⱼ₌₁^{N}^{_{C}}. Regarding the execution speed of compute nodes, a system can consider vector e:=[ₑ₁, . . . , e_{N}_{_{C}}]^{T} as the executing speed of machines. The communication link delay between any two compute nodes can be characterized by bandwidth. For example, denote B_{i,j} as the communication bandwidth of the link from compute node Cⱼ to compute node Cⱼ. In case of two machines not being connected to each other, a system can assume the corresponding bandwidth is zero (infinite time for communication delay).

A task-scheduling scheme can map tasks to compute nodes according to a given objective. Formally speaking, a task scheduler can be represented as a function m(.): V_{Task}→{Cₖ}ₖ₌₁^{N}^{_{C}} where task Tᵢ, ∀i, is assigned to machine m(i). Training can be measured against at least one of two example objectives, namely makespan minimization and throughput maximization. The first objective function for task assignment is makespan minimization. In particular, a scheduler can assign tasks to compute machines such that the resulting makespan is minimized by utilizing a particular GCN able to classify tasks into machines. Makespan can depend on Earliest Start Time (EST), Earliest Finish Time (EFT), Actual Start Time (AST), and Actual Finish Time (AFT) as follows:

Definition 1: EST(Tᵢ, Cⱼ) denotes the earliest execution start time for task Tᵢ being executed on compute node Cⱼ. Note that EST(T₀, Cⱼ)=0, ∀j.

Definition 2: EFT(Tᵢ, Cⱼ) denotes the earliest execution finish time for task Tᵢ being executed on compute node Cⱼ.

Definition 3: AST(Tᵢ) and AFT(Tᵢ) denote the actual start time and the actual finish time of task Tᵢ. Regarding the computations of the aforementioned definitions for each task, one can recursively compute them starting from task T₁ according to the following formula:

$$E F T ( {T}_{i} , {C}_{j} ) = max \{ avail [ j ] , {max}_{{T}_{k} : {e}_{k , i} ∈ {T}_{T a s k}} ( A F T ( {T}_{k} ) + c o m {m}_{k , i} ) \}$$

$$E F T ( {T}_{i} , {C}_{j} ) = E S T ( {T}_{i} , {C}_{j} ) + \frac{{p}_{i}}{{e}_{j}} ,$$

where

$$c o m {m}_{i , j} := \frac{{data}_{i , j}}{{B}_{m ( {T}_{i} ) , m ( {T}_{j} )}}$$

and avail[j] indicate the earliest time at which compute node Cⱼ is ready to execute a task.

Definition 4 (Makespan): After all tasks are assigned to compute nodes for execution, the actual time for completion of a job can be equal to the actual finish time of the last task. Therefore, the makespan can be represented as makespan=max{AFT(T_{N}_{_{T}})}.

Objective 2: The second objective function for task-scheduling can be throughput maximization. Unlike makespan which is the overall execution time for a given input, the throughput stands for the average number of inputs that can be executed per unit-time in steady state. By assuming the number of inputs to be infinite and denoting N(t) as the number of inputs completely executed by a scheduler at time t, the throughput would be

$${lim}_{t \to ∞} \frac{N ( t )}{t} .$$

For a given task-assignment, the throughput of a scheduler can be 1/τ where τ is the time taken by any resource to execute an input, and it can be written as

$$τ := max \{ {max}_{{C}_{q}} \{ {t}_{q}^{comp} , {t}_{q}^{out} , {t}_{q}^{in} \} , {max}_{{C}_{q} \to {C}_{r}} {t}_{q , r} \}$$

t_{q}^{comp}: representing the computation time of compute machine C_{q} for a single input

$$( i . e . {t}_{q}^{c o m p} = \frac{{Σ}_{i : m ( {T}_{i} = {C}_{q} )} {p}_{i}}{{e}_{q}} ) ,$$

t_{q}^{out}: representing the time taken by compute machine C_{q} for outgoing interface (i.e.

$${t}_{q}^{o u t} = \frac{{Σ}_{r} {d}_{q , r}^{( n o d e )}}{{B}_{q}^{o u t}}$$

where d_{q,r}^{(node)} and B_{q}^{out} respectively indicate amount of data transferred from compute machine C_{q} to Cᵣ and maximum outgoing bandwidth of compute machine C_{q}),
t_{q}ⁱⁿ: representing the time taken by compute machine C_{q} for incoming interface (i.e.

$${t}_{q}^{i n} = \frac{{Σ}_{r} {d}_{r , q}^{( n o d e )}}{{B}_{q}^{i n}}$$

where B_{q}ⁱⁿ indicates the maximum incoming bandwidth of compute machine C_{q}),
t_{q,r}: representing the communication time taken to transfer data from compute machine C_{q} to compute machine Cᵣ (i.e. t_{q,r}=d_{q,r}^{(node)}/B_{q,r}).

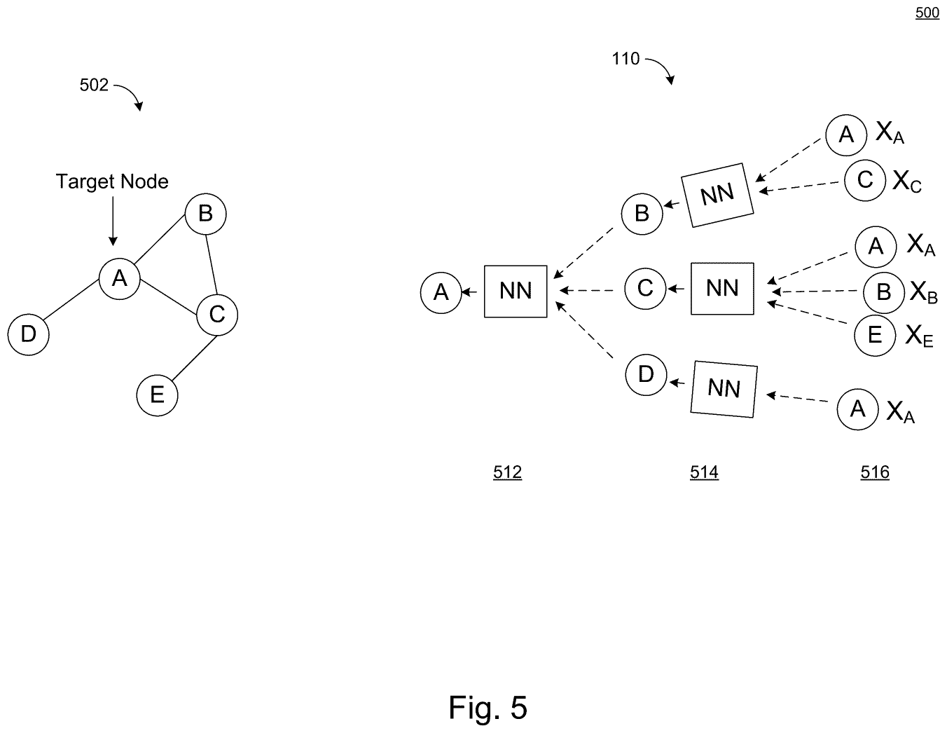

FIG. 5 illustrates a graph neural network, in accordance with present implementations, including example message-passing for the input graph shown on the left side. Regarding the notation, X_{A} represents node A's feature. Each square box indicates a deep neural network and arrows show the average messages from neighbors. As illustrated by way of example in FIG. 5, an example graph neural network 500 can include input graph 502 and neural network 510 including layers 512, 514 and 516.

Present implementations are directed to a novel machine-learning based task scheduler which can be trained with respect to aforementioned objectives. Since the nature of task-scheduling problem has to do with graphs (i.e. task graph), it is advantageous to utilize a machine-learning approach designed for capturing the underlying graph-based relationships of the task-scheduling problem. To do so, a model can automatically assign tasks to compute machines. Conventional systems lack a GCN-based scheduling scheme incorporated with both features of nodes and edges. Thus, present implementations have significant advantages over the conventional scheduling schemes. First, present implementations can remarkably reduce the computational complexity compared to previous scheduling models. Second, after training an appropriate GCN, present implementations can handle any large-scale task graph while conventional schemes severely suffer from the scalability issue.

In the GCN framework, every node can be initialized with an embedding which is the same at its feature vector. At each layer of the GCN model, nodes can take the average of neighbor messages and apply a neural network on that as follows

$${h}_{v}^{( t )} = σ ( {W}_{1}^{( t )} {h}_{v}^{( t - 1 )} + {W}_{2}^{( t )} {\sum }_{u : u ∈ 𝒩 ( v )} {h}_{u}^{( t - 1 )} )$$

where hᵥ^{(t)}, W₁^{(t)}, W₂^{(t)} and σ respectively represent the hidden vector of node v at layer t, weight matrix at layer t for self node, weight matrix at layer t for neighboring nodes, and a non-linear function (e.g. ReLU). Furthermore, N(v) indicates the neighbors of node v. After K-layers of neighborhood aggregation, returns output embedding for each node. These embeddings along with any loss function and running stochastic gradient descent can train GCN model parameters. The above scheme is suitable for undirected graphs where edges show reciprocal relationship between ending nodes.

In real applications such as social media where relations between nodes are not reciprocal, using regular GCN-based schemes might not be useful. An alternative for this type of situations is to utilize schemes designed for directed graphs such as but not limited to EDGNN where incoming and outgoing edges are treated differently in order to capture nonreciprocal relationship between nodes. In other words, EDGNN considers different weights for outgoing and incoming edges in addition to weights set for neighboring nodes. In particular, the embedding of node v would be as follows:

$${h}_{n , v}^{( t )} = σ ( \begin{matrix}{W}_{1}^{( t )} {h}_{n , v}^{( t ‐ l )} & + {W}_{2}^{( t )} {\sum }_{u : u ∈ 𝒩 ( v )} {h}_{n , u}^{( t ‐ 1 )} \\ + {W}_{3}^{( t )} & {\sum }_{u : {e}_{u , v} ∈ {E}_{T a s k}} {h}_{e , ( u , v )}^{( t ‐ 1 )} \\ + {W}_{4}^{( t )} & {\sum }_{u : {e}_{v , u} ∈ {E}_{T a s k}} {h}_{e , ( v , u )}^{( t ‐ 1 )}\end{matrix} ) ,$$

where W₁^{(t)}, W₂^{(t)}, W₃^{(t)}, and W₄^{(t)} represent weight matrices of layer t for embedding of self node, neighboring nodes, incoming edges, and outgoing edges, respectively. Moreover, h_{n,v}^{(t)} and h_{e,(u,v)}^{(t)} respectively denote embedding of node v and the embedding of the edge from node u to node v at layer t.

To train an EDGNN-based model, present implementations carefully design the input graph components, namely adjacency matrix, nodes' features, edges' features, and labels. It should be noted that present implementations are not limited to a particular criterion and can learn from two scheduling schemes with different objectives. A designed input graph can be fed into the EDGNN and the model can be trained according to labels generated from a given scheduling scheme.

The designed input graph can be based on the original task graph with the same set of nodes and edges for our input graph as the task graph. In other words, by representing the input graph as Gᵢₙₚᵤₜ:=(Vᵢₙₚᵤₜ,Eᵢₙₚᵤₜ), a system can have Vᵢₙₚᵤₜ:=V_{Task} and Eᵢₙₚᵤₜ:=E_{Task}. An aspect having an efficacious GCN-based scheduler has to do with carefully designing the features of nodes and edges as well as the labels. The feature of node Tᵢ, ∀Tᵢ ∈Vᵢₙₚᵤₜ, is denoted by x_{n,i} and it has the following N_{C}-dimension features:

$${x}_{n , i} := {( \frac{{p}_{i}}{{e}_{1}} , \frac{{p}_{i}}{{e}_{2}} , … , \frac{{p}_{i}}{{e}_{{N}_{C}}} )}^{T} ∈ {{N}_{C}}^{}$$

The intuition behind x_{n,i} is that these features represent the required computational time of task Tᵢ across all compute machines. The feature of edge e_{u,v}, ∀e_{u,v} ∈Eᵢₙₚᵤₜ, is denoted by x_{e,(u,v)} and it has the following N_{C}²-dimension features:

$${x}_{e , ( u , v )} := {( \frac{{d}_{u , v}}{{B}_{1 , 1}} , \frac{{d}_{u , v}}{{B}_{1 , 2}} , … , \frac{{d}_{u ,} v}{{B}_{{N}_{C} , {N}_{C}}} )}^{T} ∈ {{N}_{C}^{2}}^{}$$

x_{e,(u,v)} can represent the time for transferring the result of executing task Tᵤ to the following task Tᵥ across all possible pair-wise compute machines.

Objective-Dependent Labeling can be based on what task scheduler our method should learn from (which can be the “teacher” scheduler, namely, HEFT for makespan minimization and TP-HEFT for throughput maximization). Present implementations can label all nodes as well as edges. Define L_{n,v} and L_{e,(u,v)} as labels of node v and edge e_{u,v}, respectively. Regarding nodes' labeling, the label of node Tᵢ, ∀i can be the index of compute node that the teacher model assigns task Tᵢ to run on. Thus, for makespan minimization: L_{n,v}=m_{HEFT}(v) ∀v∈V_{Input} where m_{HEFT}(.) is the mapper function of HEFT model. For throughput maximization: L_{n,v}=m_{TP-HEFT}(v) ∀v∈Vᵢₙₚᵤₜ where m_{TP-HEFT}(.) is the mapper function of the TP-HEFT model. Finally, a system can label each edge according to the label of the ending vertex it is from. In other words, L_{e,(u,v)}=L_{n,u} ∀v,v such that e_{u,v} ∈Eᵢₙₚᵤₜ. This edge-labeling is advantageous in enforcing the model to learn to label out-going edges of a node with same label as its corresponding node label.

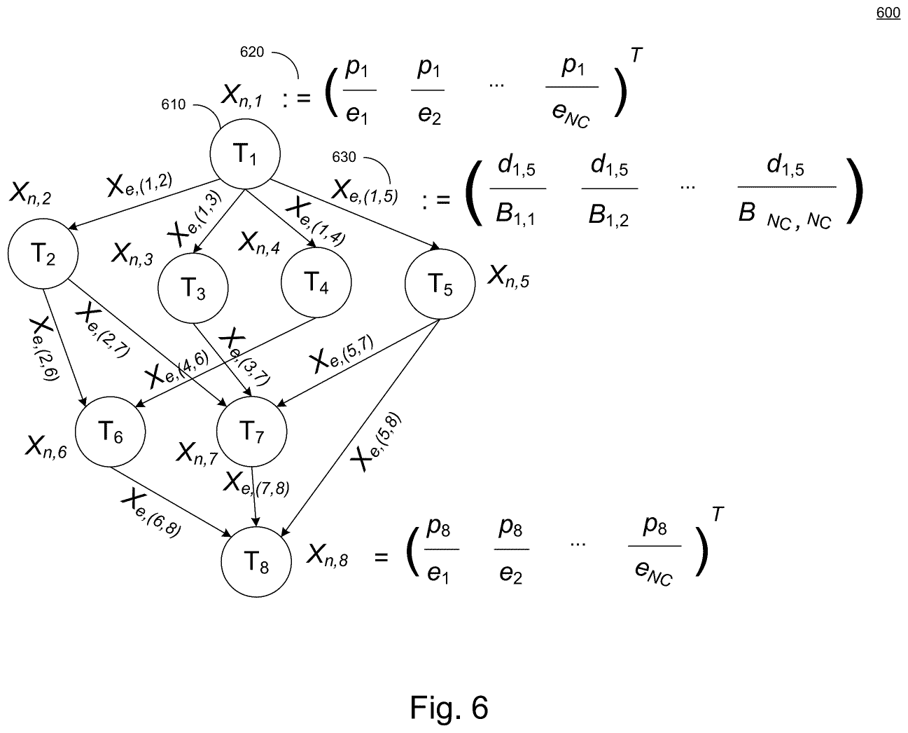

FIG. 6 illustrates an input graph 600, in accordance with present implementations, including an input graph fed into the EDGNN model for the example of the task graph. Model parameters can correspond to a 4-layer EDGCN with 128 nodes per layer with ReLU activation function and 0 dropout. Since a system can suppose nodes and edges have features, where both nodes and edges can be embedded. For training the model, a sufficiently large graph can be input. However, since the HEFT and TP-HEFT models are extremely slow in performing task-scheduling for large-scale task graphs, obtaining labels (i.e. determining the machine each task need to be executed on) for a single large graph is cumbersome. Therefore, a system can create a large graph Gᵤₙᵢₒₙ by taking the union of disjoint medium-size graphs G's (i.e., Gᵤₙᵢₒₙ:={Gᵢ}ᵢ₌₁^{N}^{_{g}}) such that HEFT and TP-HEFT can handle scheduling tasks over each of them. Regarding splitting dataset, 60%, 20%, and 20% of the disjoint graphs for training, validation, and test, respectively. This allows the teacher models to train a GCNScheduler for even larger graphs than the teacher models themselves can handle efficiently.

The performance of a GCNScheduler can be demonstrated in terms of two criteria, namely the makespan minimization and the throughput maximization, for various task graphs (medium-scale and large-scale task graphs as well as the task graphs of three real perception applications. For each criterion, the performance of GCNScheduler can be measured as well as the time it takes to assign tasks and compare these values with the corresponding values of benchmarks (i.e. HEFT/TP-HEFT and the random task-scheduler).

As far as network settings are concerned, the computation amount of tasks, the execution speed of compute machines, and the communication bandwidth can be drawn randomly from uniform distributions. For simplicity, a system can assume each task produces the same amount of data after being executed. Regarding task graphs can include generating random DAGs in two different ways, by: 1) establishing an edge between any two tasks with a given probability (e.g., edge probability (EP)), then pruning them such that it forms a DAG, or 2) specifying the width and depth of the graph, then randomly selecting successive tasks for each task.

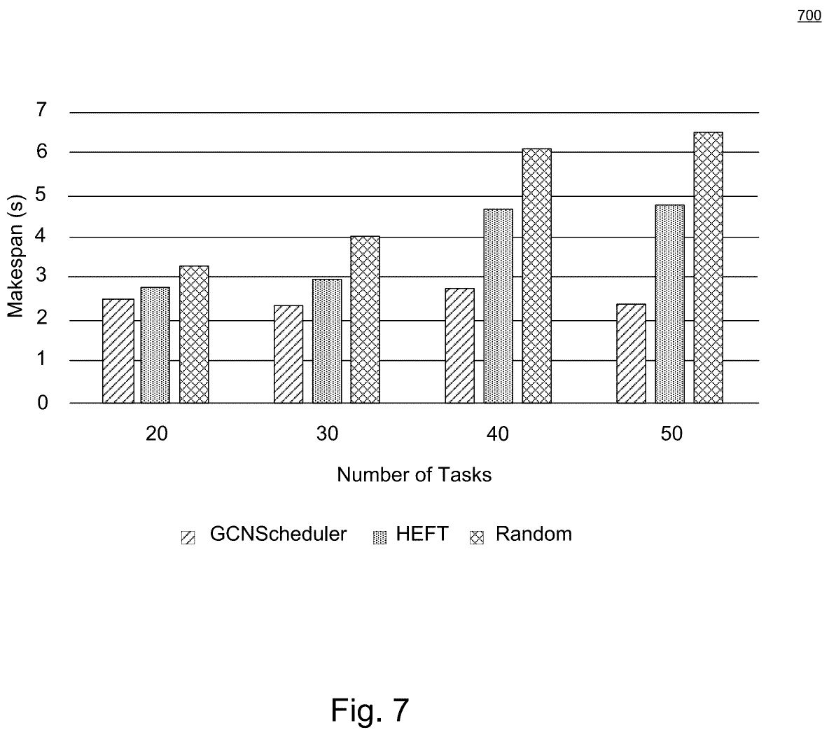

FIG. 7 illustrates a first makespan performance diagram 700, in accordance with present implementations, including example Makespan of GCNScheduler, HEFT, and the random scheduler in small settings for different number of tasks with EP=0.25.

For training the model, since the teacher scheduler, i.e. the HEFT model is extremely slow in generating labels for large task graphs, a sufficient number (approximately 400) of random medium-size task graphs can be created (i.e. each has 50 nodes with either an EP=0.25 or a width and depth of 5 and 10, respectively, for example) and tasks for each of these medium-size task graphs can be labeled according to the HEFT. By doing so, a single large-scale graph can be created which is the union of disjoint medium-size graphs. Within 15 seconds, present implementations can train our model with such a large graph. After training the model, a system can consider both medium-scale and large-scale task graphs as input samples. Then our model labels the tasks and determines what machine will execute each task. A system can next measure the performance of GCNScheduler over medium-scale and large-scale task graphs as well as the task graphs of the three real perception applications.

A model trained in accordance with present implementations significantly outperforms the random taskscheduler and considerably improves the makespan compared to HEFT, specially as number of tasks increases. The makespan of executing all tasks is more important rather than the accuracy of labeling tasks, and in this regard GCNScheduler does better than HEFT. HEFT is unable to prevent assigning tasks to machines with poor communication bandwidth while GCNScheduler is able to learn to do so more consistently, based at least partially on the features of edges in the input to GCNScheduler which explicitly take communication bandwidth between machines into account.

The time taken to assign tasks to compute machines for both GCNScheduler and HEFT is presented in Table 1. As one can easily see, GCNScheduler outperforms HEFT by 3-7 orders of magnitude. This clearly shows GCNScheduler is a game-changer for task scheduling.

TABLE 1
Time taken (in seconds) by GCNScheduler and HEFT to perform
scheduling for mediumscale task graphs with different number of tasks.

| | N_{T} | | | |
|---|---|---|---|---|
| | 20 | 30 | 40 | 50 |
| GCNSch. | 0.0026 | 0.0027 | 0.0029 | 0.0037 |
| HEFT | 0.6764 | 9.4330 | 117.35 | 1552.0 |

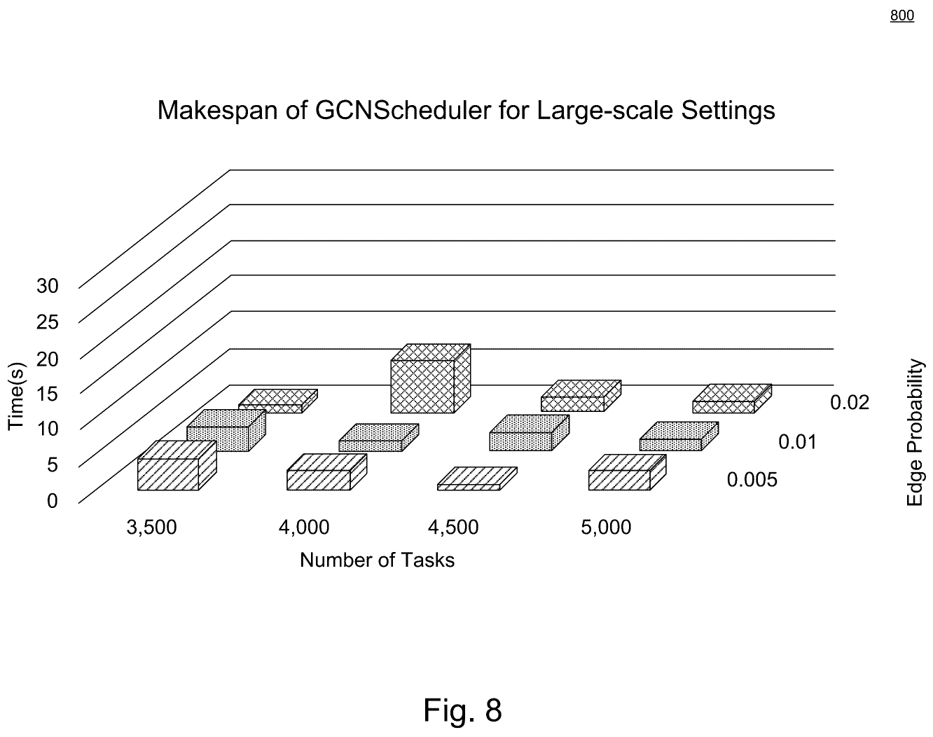

FIG. 8 illustrates a second makespan performance diagram 800, in accordance with present implementations, including example Makespan of GCNScheduler for large-scale task graphs with different number of tasks and different EP.

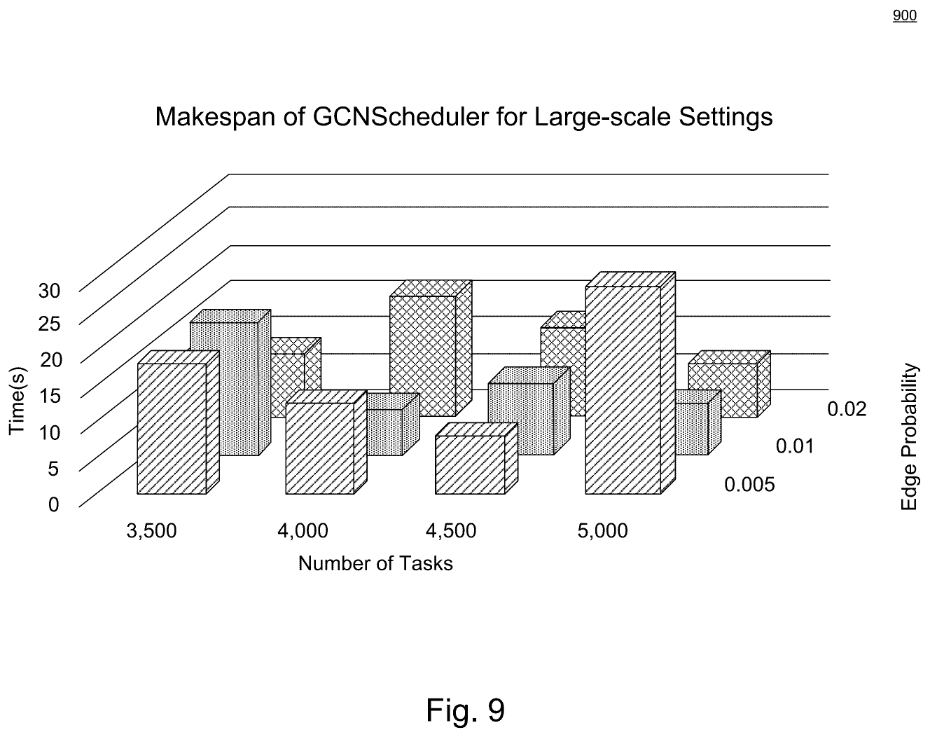

FIGS. 8 and 9 show the average makespan of an example GCNScheduler (FIG. 8) and the random task-scheduler (FIG. 9) in large-scale settings where number of tasks varies from 3,500 to 5,000 and the edge probability (i.e. EP) takes 0.005, 0.01, and 0.02. The present GCNScheduler significantly reduces makespan by a factor of 8 (for larger EP). The significant gain for larger EP (i.e. node's degrees are larger) can be responsive to some tasks that may require more predecessor tasks to be executed in advance (because of having larger nodes' degree), hence randomly assigning tasks may potentially assign one of the predecessor task to a machine with poor computing power or communication bandwidth, resulting in a larger average makespan. However, GCNScheduler efficiently exploits inter-task dependencies as well as network settings information (i.e. execution speed of machines and communication bandwidth across machines) through carefully-designed node and edge features; therefore it leads to a remarkably lower makespan.

FIG. 9 illustrates a third makespan performance diagram 900, in accordance with present implementations, including an example Makespan of the random scheduler for large-scale task graphs with different number of tasks and different EP.

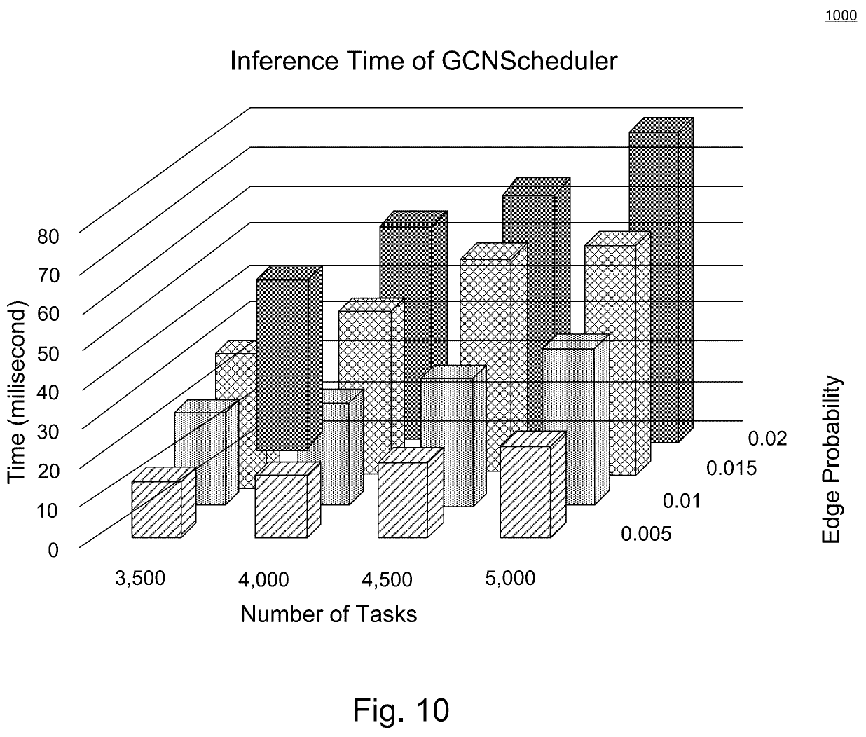

FIG. 10 illustrates an inference time diagram 1000, in accordance with present implementations. FIG. 10 illustrates an example inference time of a GCNScheduler for large-scale task graphs with different number of tasks and different EP. Inference time can correspond to time taken to assigning tasks to compute machines. Present implementations can take less than 80 milliseconds to obtain labels for each of these large-scale task graphs. Present implementations can thus advantageously efficiently operate over complicated jobs each of which may have thousands of tasks with any inter-task dependencies.

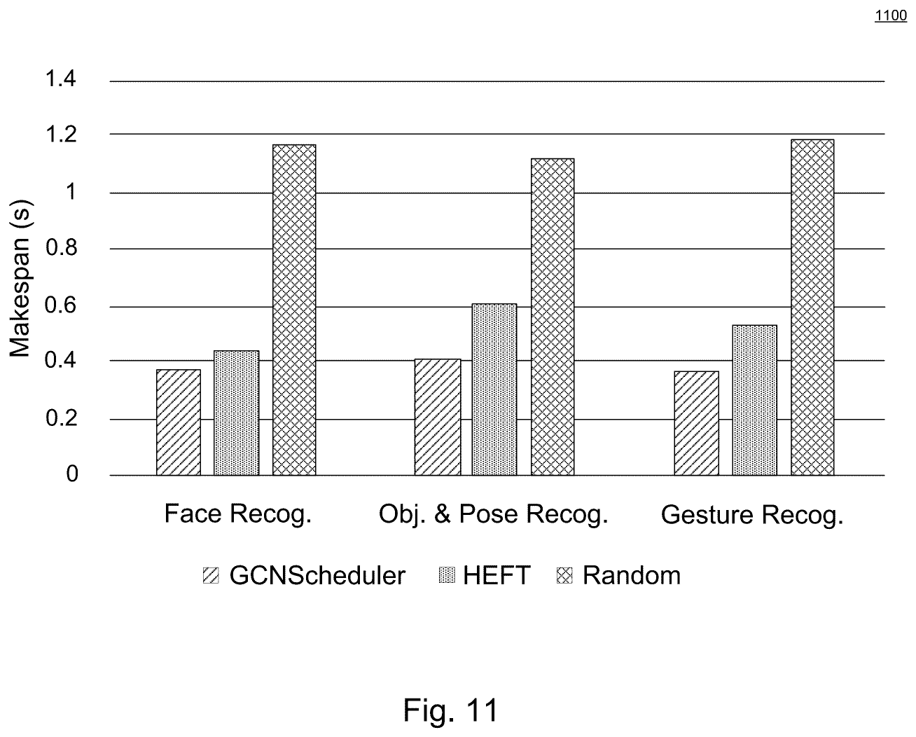

FIG. 11 illustrates a fourth makespan performance diagram 1100, in accordance with present implementations. FIG. 11 illustrates an example Makespan of GCNScheduler (with the makespan-minimization objective), HEFT, and the random task-scheduler for the three real perception applications.

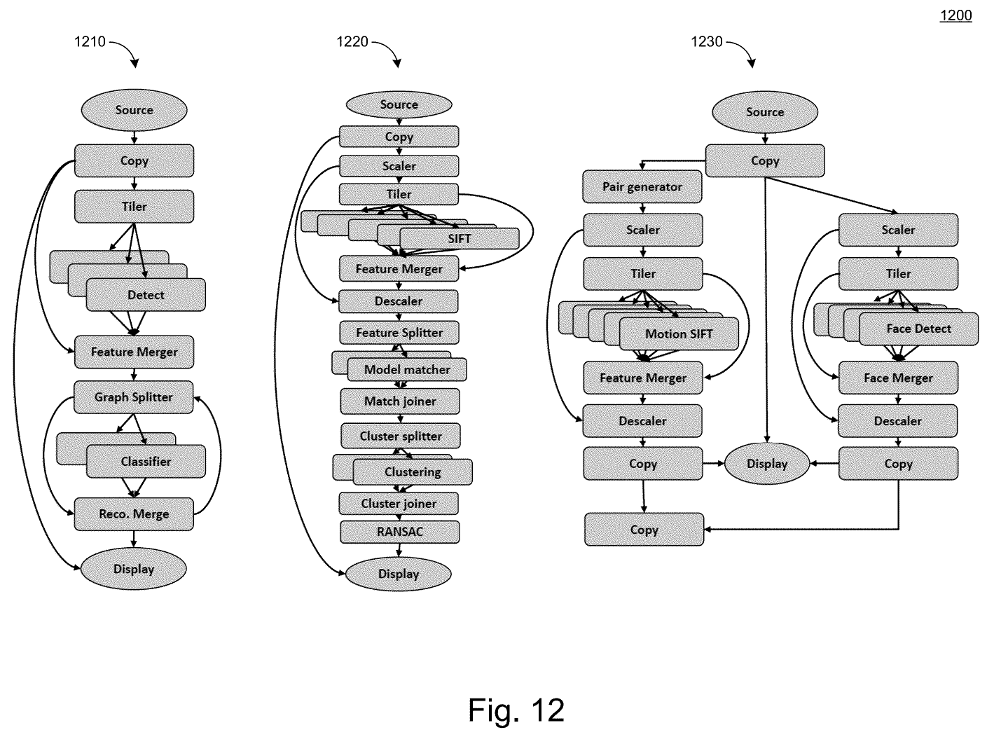

Present implementations can advantageously apply to real applications, including at least face recognition, object-and-pose recognition, and gesture recognition with corresponding task graphs depicted in FIG. 12. A system can measure the makespan of each application by running GCNScheduler with the makespan-minimization objective over the input graphs obtained from original task graphs. FIG. 11 illustrates the makespan of GCNScheduler with the makespan-minimization objective against HEFT and the random task-scheduler for the three perception applications.

TABLE 2
Time taken (in milliseconds) by GCNScheduler and HEFT.

| | Face Recog. | Pose Recog. | Gesture Recog. |
|---|---|---|---|
| GCNSch. | 0.460 | 0.524 | 0.621 |
| HEFT | 227.7 | 1484 | 443.0 |

For the purpose of maximizing throughput, TP-HEFT can be the teacher scheduler for training a GCNScheduler. Present implementations can create sufficient number of random medium-size task graphs (i.e. each of which has around 40 tasks with the width and depth of 5 and 8, respectively) and label tasks according to the TP-HEFT model, and can then build a single largescale graph, which is the union of disjoint medium-size graphs, and train GCNScheduler with the throughput-maximization objective. Table 3 shows the throughput of GCNScheduler (with the throughput-maximization objective) compared to TP-HEFT and the random task-schedulers for medium-size task graphs with different number of tasks. GCNScheduler leads to higher throughput compared to TP-HEFT scheduler, while it significantly outperforms random task-scheduler.

TABLE 3
Throughput of GCNScheduler (with the throughput-maximization
objective), Throughput(TP)-HEFT model, and the random task-
scheduler for medium-size task graphs with different number of tasks.

| | N_{T} | | | |
|---|---|---|---|---|
| | 100 | 200 | 300 | 400 |
| GCNSch. | 3.1254 | 3.1251 | 3.1261 | 3.1185 |
| TP-HEFT | 2.1731 | 2.1690 | 1.8034 | 2.0046 |
| Random | 0.0193 | 0.01801 | 0.0174 | 0.0177 |

Table 4 also shows the time taken to schedule tasks. Moreover, the accuracy of models of present implementations is at least 95%.

TABLE 4
Time taken (in seconds) by GCNScheduler (with the throughput-
maximization objective) and TP-HEFT to schedule for medium-
size task graphs with different number of tasks.

| | N_{T} | | | |
|---|---|---|---|---|
| | 100 | 200 | 300 | 400 |
| GCNSch. | 0.0033 | 0.0049 | 0.0071 | 0.0078 |
| TP-HEFT | 6.9235 | 27.229 | 70.940 | 115.221 |

Since TP-HEFT and other scheduling schemes are extremely slow for very large task graphs (e.g. task graphs with few thousands tasks), a system can only compare the throughput of SCNScheduler against the random task-scheduler, as shown in Table 5.

TABLE 5
Throughput of GCNScheduler (with the throughput-maximization
objective) and the randomtask-scheduler for large-scale task graphs.

| | N_{T} | | | |
|---|---|---|---|---|
| | 3,500 | 4,000 | 4,500 | 5,000 |
| GCNSch. | 2.9737 | 2.9731 | 2.9733 | 2.9734 |
| Random | 0.6344 | 0.6336 | 0.6332 | 0.6331 |

Further, Table 6 shows the time taken for assigning tasks to compute nodes for large-scale task graphs. GCNScheduler (with the throughput-maximization objective) is advantageously fast while handling large-scale task graphs.

Time taken (in milliseconds) by GCNScheduler (with throughput
objective) to schedule.

| | N_{T} | | | |
|---|---|---|---|---|
| | 3,500 | 4,000 | 4,500 | 5,000 |
| GCNSch. | 66.050 | 74.978 | 83.817 | 87.388 |

FIG. 12 illustrates task graphs 1200 further to the example diagram of FIG. 11, including example task graphs of the three perception application.

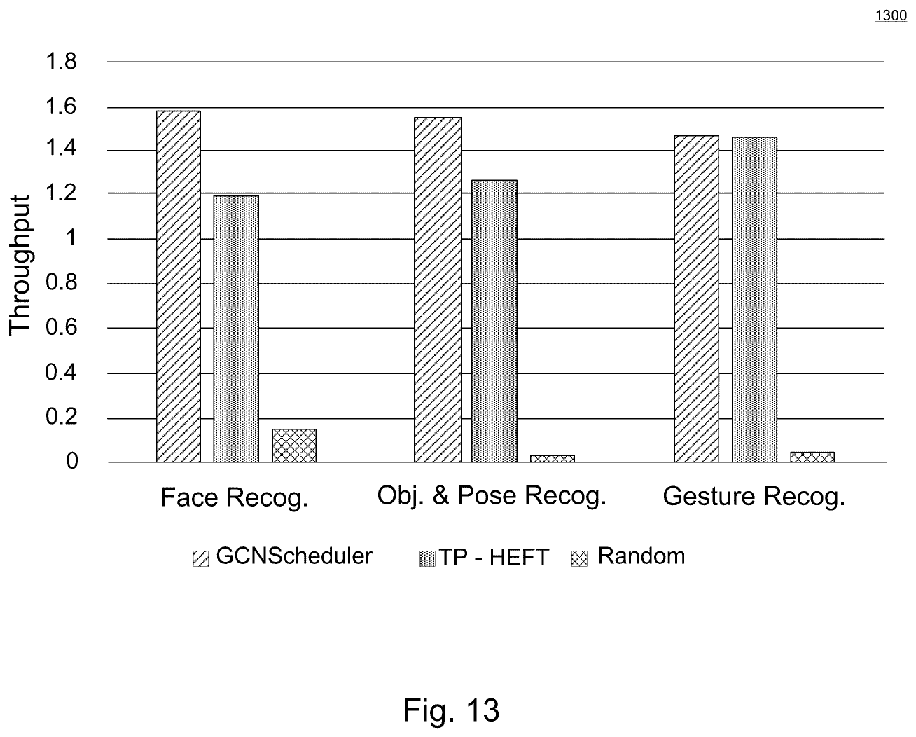

An example GCNScheduler can have particular performance by way of example, given the task graph of the three real perception applications including the face recognition, the object-and-pose recognition, and the gesture recognition. In particular, a trained GCNScheduler (with the throughput-maximization objective) can be output based on the input graphs and can measure the throughput for each application. FIG. 13 shows the throughput of an example GCNScheduler (with the throughput-maximization objective) compared to TP-HEFT and the random task-scheduler for the three perception applications. A GCNScheduler in accordance with present implementations can advantageously significantly (2-3 orders of magnitude) reduce the time taken to perform task-assignment as shown in Table 7.

TABLE 7
Time taken (in milliseconds) by GCNScheduler (with the throughput-
maximization objective) and TP-HEFT to perform scheduling for the
task graph of the three real perception applications.

| | Face Recog. | Pose Recog. | Gesture Recog. |
|---|---|---|---|
| GCNSch. | 0.488 | 0.511 | 0.560 |
| TP-HEFT | 87.34 | 257.8 | 290.1 |

FIG. 13 illustrates a throughput performance diagram 1300 further to the example diagram of FIG. 12, including example throughput of GCNScheduler (with throughput objective), TP-HEFT, and random scheduler for the task graph of the three real perception applications.

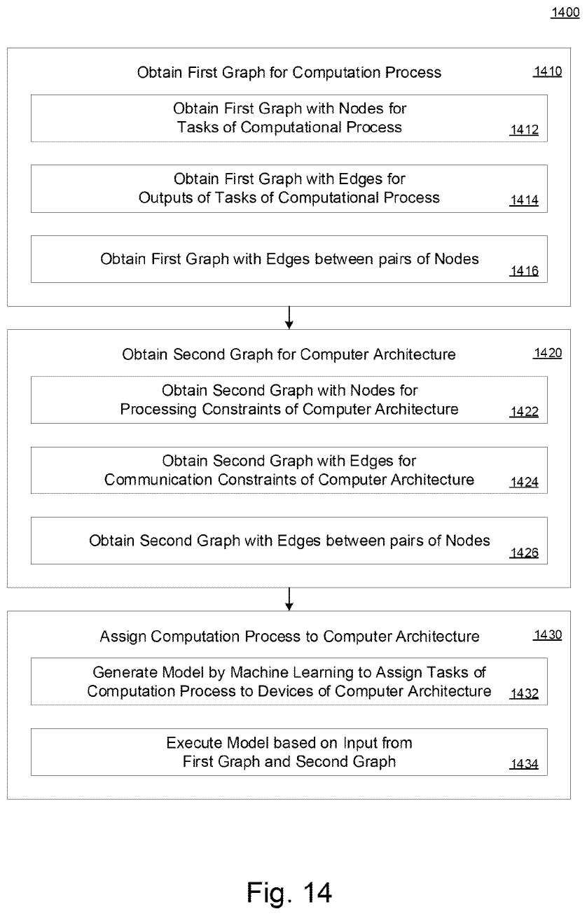

FIG. 14 illustrates a method of scheduling distributed computing based on computational and network architecture, in accordance with present implementations. At least one of the example systems 100-300 can perform method 1400 according to present implementations. The method 1400 can begin at step 1410.

At 1410, the method 1400 can obtain a first graph corresponding to a computation process. A computation process can correspond to a divisible set of instructions. A divisible set of instructions can include, for example, a set of instructions that can be grouped in accordance with a type of instruction, a type of input data, a type of output data, a type of operation, or any combination thereof. The divisible set of instructions can include one or more instructions grouped or compatible with grouping with a particular device or plurality of devices of computer architecture, a plurality of outputs of the computation process, or any combination thereof. 1410 can include at least one of 1412, 1414 and 1416. At 1412, the method 1400 can obtain a first graph corresponding to a computation process and including one or more nodes corresponding to tasks of a computational process. The first graph can include a directed or undirected graph including one or more node objects connected by one or more edge objects. Each node of the first graph can correspond to a particular instruction or group of instructions of the computation process. The computation process can be agnostic to or independent of, for example a particular computer architecture or any computer architecture. The computation process can include one or more operations independent of a computer architecture and operations compatible with a particular type of data structure or a particular type of computer architecture. For example, the computation process can be compatible with a parallel processor or a transform processor based on instructions of the computation process compatible with a parallelization process or optimized for a particular hardware-based transformation instruction. At 1414, the method 1400 can obtain a first graph corresponding to a computation process and including one or more edges corresponding to outputs of corresponding tasks. Outputs can include, for example, a type of output, a value of output, and a structure of output. A structure of output can include, for example, a bit structure, or an object class structure. At 1416, the method 1400 can obtain a first graph including one or more edges between corresponding pairs of nodes. The method 1400 can then continue to 1420.

At 1420, the method 1400 can obtain a second graph corresponding to a computer architecture. A computer architecture can correspond to a particular arrangement of a plurality of computing devices. Computing devices can include a computer processor of a particular type or model, a computer register, a computer memory, an integrated device including one or more processors or memory, or any combination thereof. For example, a second graph can include a plurality of nodes each including one or more processing constraints each corresponding to a particular computing device in a computer architecture. A computer architecture can include, for example, a distributed computing environment including a plurality of computing devices, or a high-scale computing environment including one or more computing devices, servers, supercomputers, or any combination thereof 1420 can include at least one of 1422, 1424 and 1426. At 1422, the method 1400 can obtain a second graph corresponding to a computer architecture and including one or more nodes corresponding to processing constraints of corresponding devices of a network architecture. A processing constraint can include, for example, a speed of performing particular instructions, a number of instructions that can be performed in parallel, a speed of performing instructions of any type, a storage capacity, or any combination thereof. At 1424, the method 1400 can obtain a second graph corresponding to a computer network architecture and including one or more edges corresponding to communication constraints of corresponding devices of a network architecture. At 1426, the method 1400 can obtain a first graph including one or more edges between corresponding pairs of nodes. The method 1400 can then continue to 1430.

At 1430, the method 1400 can assign a computation process to a computer architecture. For example, the method 1400 can generate a task graph to control execution of one or more computing devices of a computer architecture to execute one or more tasks of the computation process by the devices of the computer architecture. For example, the method 1400 can modify operation of the computer architecture to optimize execution of one or more instructions of a particular type or group. This optimization can provide a technical improvement of reducing computations resources including processor energy expenditure, waste heat, and degradation of instantaneous and long-term performance of high-scale and distributed computing systems. An instruction of a particular type can include, for example, an instruction corresponding to hardware of a processor of a particular type. An instruction of a particular 1430 can include at least one of 1432 and 1434. At 1432, the method 1400 can generate a model by machine learning to assign tasks of a computation process to devices of a computer network architecture. For example, the method 1400 can generate a model based on one or more first metrics each associated with computational factors of corresponding ones of the first nodes. For example, the method 1400 can generate a model based on one or more second metrics each associated with processing factors of corresponding ones of the second nodes. For example, the method 1400 can generate a model based on one or more third metrics each associated with output factors of corresponding ones of the first edges. For example, the method 1400 can generate a model based on one or more fourth metrics each associated with bandwidth factors of corresponding ones of the second nodes. For example, the method 1400 can generate a model based on an existing scheduling model as a teacher model to train the model. For example, the machine learning model can include a graph convolutional network model.

At 1434, the method 1400 can execute a model based on one or more of the first graph and the second graph as input. For example, the method 1400 can execute a model by modifying operation of a computing system or one or more devices thereof. For example, the method 1400 can execute a model by modifying operation of a computing system or one or more devices thereof in response to one or more metrics corresponding to performance of a computing system or one or more devices thereof. For example, the method 1400 can map the graph to hardware of a distributed computing system based on the trained model. For example, the first graph and the second graph can each comprise a respective directed graph.

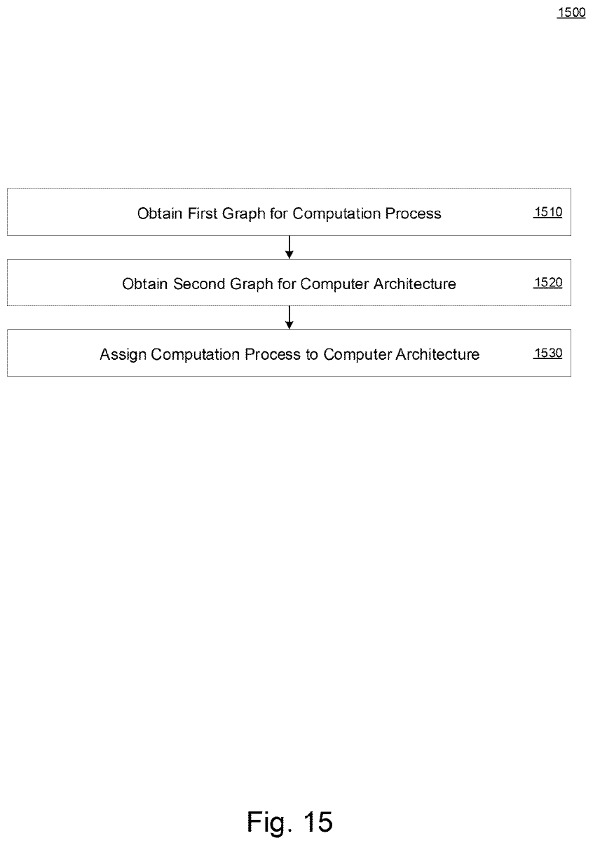

FIG. 15 illustrates a method of scheduling distributed computing based on computational and network architecture, in accordance with present implementations. At least one of the example systems 100-300 can perform method 1500 according to present implementations. The method 1500 can begin at step 1510. At 1510, the method 1500 can obtain a first graph corresponding to a computation process. 1510 can correspond at least partially in one or more of structure and operation to 1410. The method 1500 can then continue to 1520. At 1520, the method 1500 can obtain a second graph corresponding to a computer architecture. 1520 can correspond at least partially in one or more of structure and operation to 1420. The method 1500 can then continue to 1530. At 1530, the method 1500 can assign a computation process to a computer architecture. 1530 can correspond at least partially in one or more of structure and operation to 1430.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

1. A method comprising:
obtaining a first graph corresponding to a computational process, the graph including one or more first nodes corresponding to respective tasks of the computational process, and one or more first edges between pairs of the first nodes, each of the first edges corresponding to respective output from a first task of the tasks to a second task of the tasks;
obtaining a second graph corresponding to a computer network architecture, the graph including one or more second nodes corresponding to processing constraints at particular devices of the computer network architecture, and one or more second edges between the nodes each corresponding to communication constraints between particular devices; and
generating, by a machine learning process, a trained model as output, the trained model obtaining as input a combination of the first graph and the second graph, and indicating an assignment of one or more of the tasks to one or more of the devices.

2. The method of claim 1, wherein the generating is based on one or more first metrics each associated with computational factors of corresponding ones of the first nodes.

3. The method of claim 1, wherein the generating is based on one or more second metrics each associated with processing factors of corresponding ones of the second nodes.

4. The method of claim 1, wherein the generating is based on one or more third metrics each associated with output factors of corresponding ones of the first edges.

5. The method of claim 1, wherein the generating is based on one or more fourth metrics each associated with bandwidth factors of corresponding ones of the second nodes.

6. The method of claim 1, wherein the first graph and the second graph each comprise a respective directed graph.

7. The method of claim 1, wherein the machine learning model comprises a graph convolutional network model.

8. The method of claim 1, wherein the generating is based on an existing scheduling model as a teacher model to train the model.

9. The method of claim 1, further comprising:
mapping the graph to hardware of a distributed computing system based on the trained model.

10. A system comprising:
a memory and a processor to:
obtain a first graph corresponding to a computational process, the graph including one or more first nodes corresponding to respective tasks of the computational process, and one or more first edges between pairs of the first nodes, each of the first edges corresponding to respective output from a first task of the tasks to a second task of the tasks;
obtain a second graph corresponding to a computer network architecture, the graph including one or more second nodes corresponding to processing constraints at particular devices of the computer network architecture, and one or more second edges between the nodes each corresponding to communication constraints between particular devices; and
generate, by a machine learning process, a trained model as output, the trained model obtaining as input a combination of the first graph and the second graph, and indicating an assignment of one or more of the tasks to one or more of the devices.

11. The system of claim 10, the processor to:
generate the trained model based on one or more first metrics each associated with computational factors of corresponding ones of the first nodes.

12. The system of claim 10, the processor to:
generate the trained model based on one or more second metrics each associated with processing factors of corresponding ones of the second nodes.

13. The system of claim 10, the processor to:
generate the trained model based on one or more third metrics each associated with output factors of corresponding ones of the first edges.

14. The system of claim 10, the processor to:
generate the trained model based on one or more fourth metrics each associated with bandwidth factors of corresponding ones of the second nodes.

15. The system of claim 10, wherein the first graph and the second graph each comprise a respective directed graph.

16. The system of claim 10, wherein the machine learning model comprises a graph convolutional network model.

17. The system of claim 10, the processor to:
generate the trained model based on an existing scheduling model as a teacher model to train the model.

18. The system of claim 10, the processor to:
map the graph to hardware of a distributed computing system based on the trained model.

19. A computer readable medium including one or more instructions stored thereon and executable by a processor to:
obtain, by the processor, a first graph corresponding to a computational process, the graph including one or more first nodes corresponding to respective tasks of the computational process, and one or more first edges between pairs of the first nodes, each of the first edges corresponding to respective output from a first task of the tasks to a second task of the tasks;
obtain, by the processor, a second graph corresponding to a computer network architecture, the graph including one or more second nodes corresponding to processing constraints at particular devices of the computer network architecture, and one or more second edges between the nodes each corresponding to communication constraints between particular devices; and
generate, by the processor via a machine learning process, a trained model as output, the trained model obtaining as input a combination of the first graph and the second graph, and indicating an assignment of one or more of the tasks to one or more of the devices.

20. The computer readable medium of claim 19, wherein the computer readable medium further includes one or more instructions executable by the processor to:
generate the trained model based on one or more first metrics each associated with computational factors of corresponding ones of the first nodes, based on one or more second metrics each associated with processing factors of corresponding ones of the second nodes, and based on one or more fourth metrics each associated with bandwidth factors of corresponding ones of the second nodes.
